(19) United States
(12) Patent Application Publication
(10) Pub. No.: US 2017/0021681 A1
(43) Pub. Date: Jan. 26, 2017

(54) METHOD AND APPARATUS FOR MONITORING TIRE PRESSURE USING ZERO CROSSING

(71) Applicant: HYUNDAI AUTRON CO., LTD., Seongnam-si (KR)

(72) Inventors: Tae-Hun KIM, Yongin-si (KR); Dong-Jin NA, Seongnam-si (KR)

(21) Appl. No.: 15/217,018

(22) Filed: Jul. 22, 2016

(30) Foreign Application Priority Data
Jul. 24, 2015 (KR) 10-2015-0104763

(51) Int. Cl. B60C 23/04

(52) U.S. Cl. CPC B60C 23/0488

(57) ABSTRACT

The present invention relates to a method and an apparatus for monitoring a tire pressure using zero crossing. Provided is a tire pressure monitoring method using zero crossing including: acquiring a wheel speed signal of a vehicle; interpolating the obtained wheel speed signal by a fixed time; calculating a maximum value of the interpolated wheel speed signal using a time range of zero crossing; calculating a changed amount of the maximum value by comparing the maximum value of the calculated wheel speed signal and the maximum value of the predetermined normal pressure; and determining a low pressure of a tire mounted on a vehicle using the calculated changed amount of the maximum value.

### CROSS-REFERENCE TO RELATED APPLICATIONS

This application claims priority to and the benefit of Korean Patent Application No. 10-2015-0104763 filed in the Korean Intellectual Property Office on Jul. 24, 2015, the entire contents of which are incorporated herein by reference.

### TECHNICAL FIELD

The present invention relates to a method and an apparatus for monitoring a tire pressure, and more particularly, to a method and an apparatus for monitoring a tire pressure using zero crossing.

### BACKGROUND ART

Air pressure of a tire is one of the elements that allow a vehicle to safely travel. When the air pressure of the tire is low, a vehicle easily slides which may result in a big accident. Further, fuel consumption is increased, so that fuel efficiency is lowered. Further, the life-span of the tire is shortened and ride comfort and braking force significantly deteriorate. When the air pressure of the tire decreases, functional problems including deterioration of fuel efficiency, tire wear, and the like may occur. In addition, when the decrease in air pressure is significant, there is a possibility that vehicle damage and danger to human life such as an accident occurrence caused by a driving inoperability state or tire rupture will occur.

However, since most drivers cannot recognize a change in air pressure of the tire, a tire pressure monitoring system (TPMS) which is a tire pressure monitoring system announcing the change in pressure of the tire to the drivers in real time has been developed.

In recent years, the tire pressure monitoring system (TPMS) is mounted on a vehicle, which detects the decrease in air pressure of the tire mounted on the vehicle and announces the detected decrease in air pressure to the driver.

The tire pressure monitoring system (TPMS) announces the decrease in pressure of the tire to the driver to allow the driver to check a pressure state of the tire, thereby solving the problem.

The TPMS may be generally classified into a direct scheme and an indirect scheme.

The direct scheme of TPMS installs a pressure sensor in a tire wheel to directly measure the air pressure of the tire. The direct scheme of TPMS announces the change in air pressure of the tire, which is measured from the pressure sensor attached to the tire to the driver.

The direct scheme of TPMS may accurately sense the air pressure of the tire, but the life-span of a battery is limited and whenever the tire is replaced, the direct scheme of TPMS needs to be installed again. In the direct scheme of TPMS, since a pressure sensor is attached, imbalance of the tire may occur and problems including radio frequency interference and the like may occur. Further, since the direct scheme of TPMS is a scheme that mounts the sensor on the tire to measure the air pressure, the direct scheme of TPMS has an advantage in that the direct scheme of TPMS measures accurate pressure. On the contrary, the direct scheme of TPMS is constituted by various components including a pressure measurement sensor mounted on the tire, a wireless communication unit for transmitting a measurement value in a general wireless scheme, and the like. Therefore, the direct scheme of TPMS is more expensive and further, higher in failure rate than the indirect scheme of TPMS.

Meanwhile, the indirect scheme of TPMS is a scheme that estimates a loss in air pressure by using a wheel sensor which is mounted on the vehicle to measure a wheel speed. In the indirect scheme of TPMS, since the TPMS may be implemented only by an algorithm, additional hardware is not required, which results in reduced cost. Further, just a little maintenance cost is consumed. The indirect scheme of TPMS has better price competitiveness than the direct scheme of TPMS.

The indirect scheme of TPMS indirectly estimates the change of the air pressure of the tire through change of a response characteristic (for example, a rotation speed or a frequency characteristic of the rotation speed) of the tire generated when the air pressure is lowered and announces the estimation to the driver. The direct scheme of TPMS may precisely detect the lowering of the air pressure of the tire, but a specific wheel is required therefor and performance is not good in an actual environment. Therefore, it has disadvantages in view of a technology and cost.

However, since the resonance frequency of the indirect scheme of TPMS varies depending on the wheel speed, accuracy of the indirect scheme of TPMS slightly deteriorates. Since the estimated change in air pressure of the tire may be different from an actual change, the indirect scheme of TPMS may send a false alarm to the driver.

The indirect scheme of TPMS estimates an air pressure of a tire from rotation information of the tire. The indirect scheme of TPMS may be, in detail, classified into a dynamic loaded radius (DLR) analysis scheme and a resonance frequency method (RFM) analysis scheme again. They may be briefly called a radius analysis scheme and a frequency analysis scheme. They may be briefly called a radius analysis scheme and a frequency analysis scheme.

In a frequency analysis scheme, when the air pressure of the tire decreases, a difference from a tire having a normal air pressure is detected by using when a frequency characteristic of a rotational speed signal of a wheel is changed. In the frequency analysis scheme, based on a resonance frequency which may be acquired by frequency analysis of the rotational speed signal of the wheel, when the relevant resonance frequency is calculated to be lower than a reference frequency estimated while initializing, it is determined that the air pressure of the tire decreases.

In a radius analysis scheme, by using a phenomenon in which a dynamic loaded radius of the depressurized tire decreases while driving, and as a result, the tire rotates more rapidly than the normal tire, the pressure decrease is detected by comparing rotational velocities of four tires. In the radius analysis scheme of the tire pressure monitoring system, since it is determined whether the tire is depressurized based on a wheel speed, the wheel speed exerts the largest influence on the determination of the depressurization.

In the meantime, a tire air pressure monitoring scheme may mainly determine whether the tire is in a low pressure through frequency and dynamic radius analysis.

As a frequency analysis scheme, an adaptive filter scheme and a fast Fourier transform (FFT) analysis scheme are mainly used. However, the above-mentioned two schemes are complex and require a large computational amount.

The indirect scheme of TPMS is complex and requires a large computational amount, so that a result of estimating an air pressure of a tire may be different from an actual air pressure. Therefore, the above-mentioned indirect scheme of TPMS may send a false alarm which is different from the actual situation, to the driver.

Therefore, instead of a scheme which is complex and requires a large computational amount, a technique for quickly and easily monitoring a tire pressure is required.

### SUMMARY OF THE INVENTION

Exemplary embodiments of the present invention have been made in an effort to provide a method and an apparatus for monitoring a tire pressure which calculate a maximum value of a interpolated wheel speed signal using a zero crossing time range, and compare the calculated maximum value with a maximum value of a predetermined normal pressure to calculate a changed amount of the maximum values, thereby quickly and easily determining a low pressure of a tire mounted on a vehicle in accordance with the changed amount of the maximum value.

Exemplary embodiments of the present invention have been made in an effort to further provide a method and an apparatus for monitoring a tire pressure which calculate a frequency using the number of time slots of an interpolated wheel speed signal and select a peak frequency using a frequency range count of zero crossing in which the calculated frequency is contained, thereby quickly and easily determining a low pressure of a tire mounted on a vehicle in accordance with the selected peak frequency.

Exemplary embodiments of the present invention have been made in an effort to further provide a method and an apparatus for monitoring a tire pressure which calculate a frequency using the number of time slots of an interpolated wheel speed signal, calculate a maximum value within a frequency range of zero crossing, and select a peak frequency using a maximum value within a frequency range of zero crossing in which the calculated frequency is contained, thereby quickly and easily determining a low pressure of a time mounted on a vehicle in accordance with the selected peak frequency.

A first aspect of the present disclosure provides a tire pressure monitoring method using zero crossing, including: acquiring a wheel speed signal of a vehicle; interpolating the obtained wheel speed signal by a fixed time; calculating a maximum value of the interpolated wheel speed signal using a time range of zero crossing; calculating a changed amount of the maximum value by comparing the maximum value of the calculated wheel speed signal and the maximum value of the predetermined normal pressure; and determining a low pressure of a tire mounted on a vehicle using the calculated changed amount of the maximum value.

The method may further include correcting an error of the acquired wheel speed signal.

The method may further include performing band pass filtering on the interpolated wheel speed signal in accordance with the predetermined frequency range.

In the calculating of a maximum value, a value at an inflection point at which a current value of a wheel speed signal is lower than a previous value of a wheel speed signal within a time range of zero crossing may be selected as the maximum value and an average of the selected maximum value may be calculated in real time to calculate the average maximum value.

In the calculating of a changed amount of the maximum value, the calculated average maximum value may be compared with the average maximum value of the predetermined normal pressure to calculate the changed amount of the maximum value.

In the determining of a low pressure, when the calculated changed amount of the maximum value is equal to or smaller than the predetermined reference changed amount, the tire may be determined to be at a normal pressure and when the calculated changed amount of the maximum value exceeds the predetermined reference changed amount, the tire may be determined to be at a low pressure.

A second aspect of the present disclosure provides a tire pressure monitoring method using zero crossing, including: acquiring a wheel speed signal of a vehicle; interpolating the obtained wheel speed signal by a fixed time; calculating a frequency using the number of time slots of the interpolated wheel speed signal; selecting a peak frequency using a frequency range count of zero crossing in which the calculated frequency is contained; and determining a low pressure of a tire mounted on a vehicle using the selected peak frequency.

The method may further include correcting an error of the acquired wheel speed signal.

The method may further include performing band pass filtering on the interpolated wheel speed signal in accordance with the predetermined frequency range.

In the calculating of a frequency, the frequency may be calculated using the number of time slots of the interpolated wheel speed signal during the predetermined period, in order to remove disturbance.

In the selecting of a peak frequency, a count of the frequency range may be increased by checking the frequency range of zero crossing in which the calculated frequency is contained and a frequency range having a maximum count among the increased frequency range counts may be selected as a peak frequency.

In the determining of a low pressure, when the selected peak frequency is equal to or higher than the predetermined peak frequency, the pressure may be determined as a normal pressure and when the selected peak frequency is lower than the predetermined peak frequency, the pressure may be determined as a low pressure.

A third aspect of the present disclosure provides a tire pressure monitoring method using zero crossing, including: acquiring a wheel speed signal of a vehicle; interpolating the obtained wheel speed signal by a fixed time; calculating a frequency using the number of time slots of the interpolated wheel speed signal; calculating a maximum value within a frequency range of zero crossing of the interpolated wheel speed signal; selecting a peak frequency using a maximum value within a frequency range of zero crossing in which the calculated frequency is contained; and determining a low pressure of a tire mounted on a vehicle using the selected peak frequency.

The method may further include correcting an error of the acquired wheel speed signal.

The method may further include performing band pass filtering on the interpolated wheel speed signal in accordance with the predetermined frequency range.

In the calculating of a frequency, the frequency may be calculated using the number of time slots of the interpolated wheel speed signal during the predetermined period, in order to remove disturbance.

In the calculating of a maximum value, a value at an inflection point at which a current value of a wheel speed signal is lower than a previous value of a wheel speed signal within a frequency range of zero crossing may be selected as the maximum value and the selected maximum value may be accumulated and averaged.

In the selecting of a peak frequency, the maximum values within the frequency range of zero crossing in which the calculated frequency is contained may be averaged and a frequency having the largest value among the average of the maximum value may be selected as a peak frequency.

In the determining of a low pressure, when the selected peak frequency is equal to or higher than the predetermined peak frequency, the pressure may be determined as a normal pressure and when the selected peak frequency is lower than the predetermined peak frequency, the pressure may be determined as a low pressure.

A fourth aspect of the present disclosure provides a tire pressure monitoring apparatus using zero crossing, comprising: a signal acquiring unit which acquires a wheel speed signal of a vehicle; a signal processing unit which interpolates the obtained wheel speed signal by a fixed time; a signal analyzing unit which calculates a maximum value of the interpolated wheel speed signal using a time range of zero crossing or calculates a frequency using the number of time slots of the interpolated wheel speed signal and calculates a changed amount of the maximum value or selects a peak frequency using the calculated maximum value or the frequency of the wheel speed signal; and a low pressure determining unit which determines a low pressure of a tire mounted on a vehicle using the calculated changed amount of the maximum value or the selected peak frequency.

The signal analyzing unit may calculate a changed amount of the maximum value by comparing the maximum value of the calculated wheel speed signal and the maximum value of the predetermined normal pressure.

The signal analyzing unit may select a peak frequency using a frequency range count of zero crossing in which the calculated frequency is contained.

The signal analyzing unit may calculate the maximum value within the frequency range of zero crossing of the interpolated wheel speed signal and select the peak frequency using the maximum value in the frequency range of zero crossing in which the calculated frequency is contained.

According to the exemplary embodiments of the present invention, it is possible to calculate a maximum value of an interpolated wheel speed signal using a zero crossing time range, compare the calculated maximum value with a maximum value of a predetermined normal pressure to calculate a changed amount of the maximum values, thereby quickly and easily determining a low pressure of a tire mounted on a vehicle in accordance with the changed amount of the maximum value.

According to another exemplary embodiments of the present invention, it is possible to calculate a frequency using the number of time slots of an interpolated wheel speed signal and select a peak frequency using a frequency range count of zero crossing corresponding to the calculated frequency, thereby quickly and easily determining a low pressure of a tire mounted on a vehicle in accordance with the selected peak frequency.

According to still another exemplary embodiments of the present invention, it is possible to calculate a frequency using the number of time slots of an interpolated wheel speed signal, calculates a maximum value within a frequency range of zero crossing, and select a peak frequency using a frequency range count of zero crossing corresponding to the calculated frequency, thereby quickly and easily determining a low pressure of a tire mounted on a vehicle in accordance with the selected peak frequency.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration view of a tire pressure monitoring apparatus using zero crossing according to an exemplary embodiment of the present invention.

FIG. 2 is a flowchart of a tire pressure monitoring method using zero crossing according to a first exemplary embodiment of the present invention.

FIG. 3 is a flowchart of a tire pressure monitoring method using zero crossing according to a second exemplary embodiment of the present invention.

FIG. 4 is a flowchart of a tire pressure monitoring method using zero crossing according to a third exemplary embodiment of the present invention.

FIG. 5 is an exemplary view of a wheel speed signal of tires with a low pressure and a normal pressure which is applied to an exemplary embodiment of the present invention.

FIG. 6 is an exemplary view of a band-pass filtered time sequential signal which is applied to an exemplary embodiment of the present invention.

FIG. 7 is an exemplary view of a changed amount of a maximum value of a low pressure and a normal pressure according to a first exemplary embodiment of the present invention.

FIG. 8 is an exemplary view of a count within a zero cross frequency range according to a second exemplary embodiment of the present invention.

FIG. 9 is an exemplary view of a maximum value within a zero cross frequency range according to a third exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

When the exemplary embodiment is described, a technology which is well known in the technical field of the present invention and is not directly related with the present invention will not be described. The reason is that unnecessary description is omitted to clearly transmit the gist of the present invention without obscuring the gist of the present invention.

By the same reason, in the accompanying drawings, some parts are exaggerated, omitted, or schematically illustrated. Further, an actual size is not fully reflected to the size of each component. In the drawings, like reference numerals denote like or corresponding components.

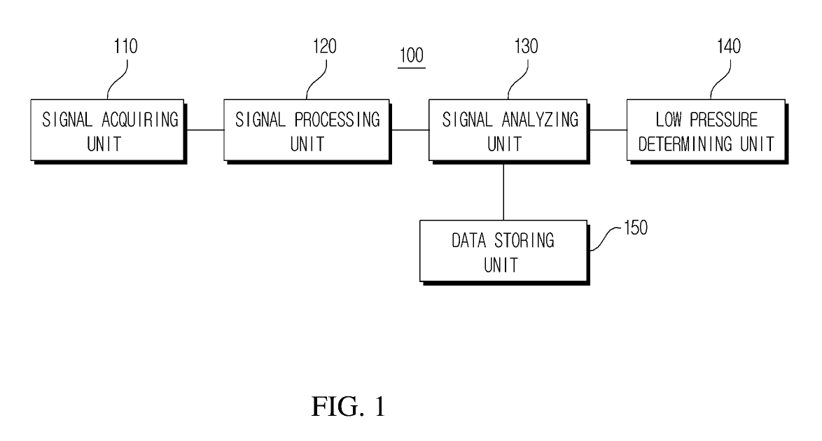

FIG. 1 is a configuration view of a tire pressure monitoring apparatus using zero crossing according to an exemplary embodiment of the present invention.

As illustrated in FIG. 1, a tire pressure monitoring apparatus 100 according to an exemplary embodiment of the present invention includes a signal acquiring unit 110, a signal processing unit 120, a signal analyzing unit 130, a low pressure determining unit 140, and a data storing unit 150. Here, the tire pressure monitoring apparatus 100 of the present disclosure may be classified into first to third exemplary embodiments depending on a low pressure determining method.

Hereinafter, a tire pressure monitoring apparatus 100 using zero crossing of FIG. 1 will be described by first to third exemplary embodiments.

First, a specific configuration and operation of each component of a tire pressure monitoring apparatus 100 according to a first exemplary embodiment of the present disclosure will be described.

The signal acquiring unit 110 acquires a wheel speed signal of a vehicle. For example, the signal acquiring unit 110 acquires a wheel speed of a wheel from a wheel speed sensor (not illustrated) provided in the vehicle. In the vehicle, four wheels including a front left wheel FL, a front right wheel FR, a rear left wheel RL, and a rear right wheel RR are mounted. The wheel speed sensor detects rotation velocities of the front left wheel FL, the front right wheel FR, the rear left wheel RL, and the rear right wheel RR. For example, the wheel speed sensor may be a wheel speed sensor which generates a rotation pulse using an electromagnetic pickup and measures a rotational angular speed and a wheel speed from a pulse number. In the meantime, the wheel speed sensor may be an angular speed sensor. Information on the rotation speed of the wheel measured by the wheel speed sensor is transmitted to the signal acquiring unit 110.

The signal processing unit 120 interpolates the wheel speed signal acquired in the signal acquiring unit 110 by a fixed time. Here, the signal processing unit 120 may correct an error of the wheel speed signal acquired in the signal acquiring unit 110 before interpolating the wheel speed signal by a fixed time. Next, the signal processing unit 120 may interpolate the wheel speed signal in which an error is corrected, by the fixed time.

The signal processing unit 120 performs band-pass filtering on the interpolated wheel speed signal in accordance with a predetermined frequency range. For example, the signal processing unit 120 performs band-pass filtering on the interpolated wheel speed signal in accordance with the frequency range of 30 Hz to 60 Hz which is an available frequency for the tire of the vehicle.

The signal analyzing unit 130 calculates a maximum value of the interpolated wheel speed signal using a time range of zero crossing. Here, the signal analyzing unit 130 may select a value at an inflection point at which a current value of a wheel speed signal is lower than a previous value of a wheel speed signal within the time range of zero crossing as the maximum value. Next, the signal analyzing unit 130 calculates an average of the selected maximum values in real time to calculate an average maximum value as represented in the following Equation 1.

$$Average maximum value ( k ) = \frac{\begin{matrix}( ( k - 1 ) \times average maximum value ( k - 1 ) + \\ maximum value ( k ) )\end{matrix}}{k} \qquad Equation 1$$

Here, the average maximum value (k) indicates a k-th average maximum value, the average maximum value (k−1) indicates a (k−1)-th average maximum value, and k indicates a k-th interpolation sampled fixed time.

The signal analyzing unit 130 compares the calculated maximum value of the wheel speed signal with a maximum value of a predetermined normal pressure to calculate a changed amount of the maximum value. Here, the signal analyzing unit 130 compares the calculated average maximum value with an average maximum value of the predetermined normal pressure to calculate a changed amount of the maximum value.

In the meantime, the low pressure determining unit 140 determines a low pressure of the tire mounted on the vehicle using the changed amount of the maximum value calculated in the signal analyzing unit 130. Here, when the calculated changed amount of the maximum value is equal to or smaller than a predetermined reference changed amount, the low pressure determining unit 140 determines that the tire is at a normal pressure. In contrast, when the calculated changed amount of the maximum value is larger than the predetermined reference changed amount, the low pressure determining unit 140 determines that the tire is at a low pressure.

Next, a specific configuration and operation of each component of a tire pressure monitoring apparatus 100 according to a second exemplary embodiment of the present disclosure will be described. Next, in order to clearly transmit the gist of the second exemplary embodiment of the present disclosure without clouding the gist, redundant description thereof will be omitted.

The signal acquiring unit 110 and the signal processing unit 120 perform the same function as those of the first exemplary embodiment of the present disclosure.

Differently from the first exemplary embodiment of the present disclosure, the signal analyzing unit 130 calculates a frequency using the number of time slots of the wheel speed signal interpolated in the signal processing unit 120. Here, the signal analyzing unit 130 calculates the frequency using the number of time slots of the wheel speed signal which is interpolated for a predetermined period.

A process of calculating a frequency will be described with reference to a specific example.

A sampling frequency of fixed time interpolation is 480 Hz. Here, the fixed time is an inverse number of the sampling frequency and is calculated such that 1/480 Hz=2.08 ms.

For example, if one period has 11 fixed times, the frequency for one period is calculated as an inverse number of a value obtained by multiplying the number of periods and the fixed time, that is, 1/(11×2.08 ms)=43.6 Hz.

Therefore, as an example of calculating the frequency, the signal analyzing unit 130 calculates a frequency as represented in the following Equation 2 using the number of time slots for 20 periods to remove disturbance.

$$Frequency = \frac{20}{20 periods \times time for one period} \qquad Equation 2$$

The signal analyzing unit 130 selects a peak frequency using a frequency range count of zero crossing in which the calculated frequency is contained. Here, the signal analyzing unit 130 checks the frequency range of zero crossing in which the frequency calculated in the signal processing unit 120 is contained to increase the frequency range count. Next, the signal analyzing unit 130 selects a frequency range having the maximum count among the increased frequency range counts as a peak frequency.

An example in which a frequency of 30 to 60 Hz is divided in the unit of 0.5 Hz will be described as a reference. The signal analyzing unit 130 checks a corresponding frequency range in a frequency range of 30 to 60 Hz obtained by dividing the frequency calculated in the signal processing unit 120 by the unit frequency of 0.5 Hz. For example, when the frequency calculated in the signal processing unit 120 is 41.7 Hz, the signal analyzing unit 130 increases a count of the frequency range of 41.5 Hz to 42 Hz by one. After the count of the frequency range is repeatedly increased, when the frequency range of 41.5 Hz to 42 Hz among the entire frequency range has a maximum count, the signal analyzing unit 130 may select the frequency range as a peak frequency.

In the meantime, the low pressure determining unit 140 determines a low pressure of the tire mounted on the vehicle using the peak frequency selected in the signal analyzing unit 130. Here, when the selected peak frequency is equal to or higher than the predetermined peak frequency, the low pressure determining unit 140 determines that the pressure is a normal pressure. In contrast, when the selected peak frequency is lower than the predetermined peak frequency, the low pressure determining unit 140 determines that the pressure is a low pressure.

Next, a specific configuration and operation of each component of a tire pressure monitoring apparatus according to a third exemplary embodiment of the present disclosure will be described. Next, in order to clearly transmit the gist of the third exemplary embodiment of the present disclosure without clouding the gist, redundant description thereof will be omitted.

The signal acquiring unit 110 and the signal processing unit 120 perform the same function as those of the first and second exemplary embodiment of the present disclosure.

Here, the signal analyzing unit 130 calculates the frequency using the number of time slots of the wheel speed signal which is interpolated in the signal processing unit 120.

Differently from the first and second exemplary embodiments of the present disclosure, the signal analyzing unit 130 calculates a maximum value in a frequency range of zero crossing of the wheel speed signal interpolated in the signal processing unit 120. Here, the signal analyzing unit 130 may select a value at an inflection point at which a current value of a wheel speed signal is lower than a previous value of a wheel speed signal within the frequency range of zero crossing as the maximum value. Next, the signal analyzing unit 130 accumulates averages of the selected maximum values.

The signal analyzing unit 130 selects a peak frequency using a maximum value within the frequency range of zero crossing in which the frequency calculated in the signal processing unit 120 is contained. Here, the signal analyzing unit 130 calculates an average of maximum values within the frequency range of zero crossing in which the frequency calculated in the signal processing unit 120 is contained. Next, the signal analyzing unit 130 selects a frequency which is the largest one in the averages of the maximum values as a peak frequency.

In the meantime, the low pressure determining unit 140 determines a low pressure of the tire mounted on the vehicle using the peak frequency selected in the signal analyzing unit 130.

In the meantime, the data storing unit 150 stores data regarding determining a low pressure of the tire mounted on the vehicle.

The data storing unit 150 stores data on the wheel speed signal, the fixed time, a maximum value of a predetermined normal pressure, a predetermined frequency range, an average maximum value of the predetermined normal pressure, a predetermined reference changed amount, a predetermined period, and a predetermined peak frequency.

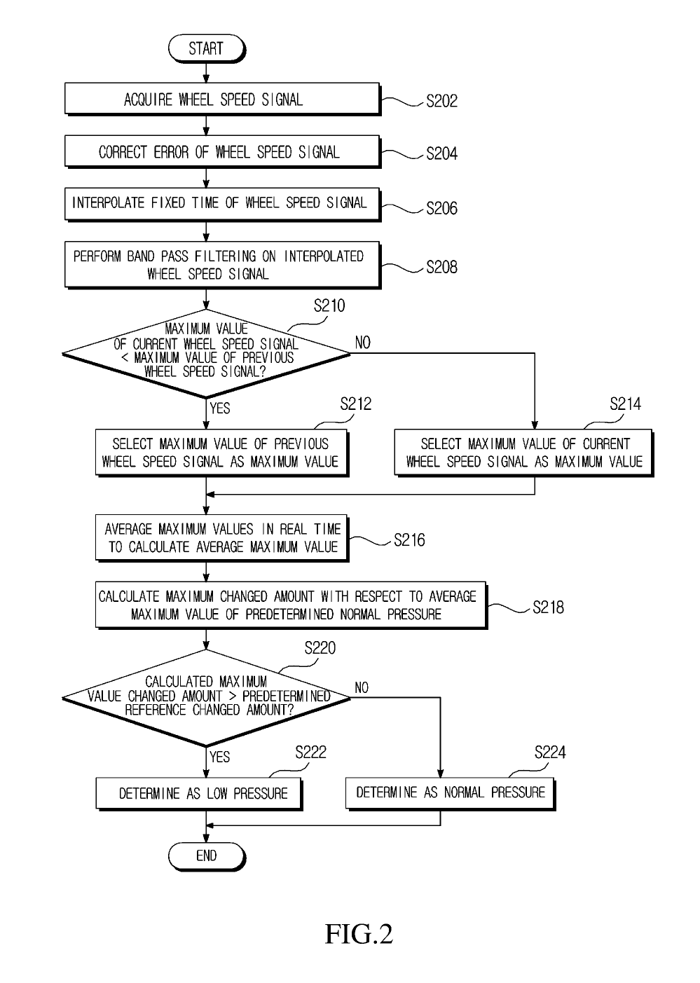

FIG. 2 is a flowchart of a tire pressure monitoring method using zero crossing according to a first exemplary embodiment of the present invention.

The signal acquiring unit 110 acquires a wheel speed signal of a vehicle in step S202.

The signal processing unit 120 corrects an error of the wheel speed signal acquired in the signal acquiring unit 110 in step S204.

The signal processing unit 120 interpolates the wheel speed signal acquired in the signal acquiring unit 110 by a fixed time in step S206.

The signal processing unit 120 performs band-pass filtering on the interpolated wheel speed signal in accordance with a predetermined frequency range in step S208.

The signal analyzing unit 130 checks whether the maximum value of the current wheel speed signal is smaller than the maximum value of the previous wheel speed signal in step S210.

As the checking result in step S210, when the maximum value of the current wheel speed signal is smaller than the maximum value of the previous wheel speed signal, the signal analyzing unit 130 selects the maximum value of the previous wheel speed signal as a maximum value in step S212.

In contrast, as the checking result in step S210, when the maximum value of the current wheel speed signal is equal to or larger than the maximum value of the previous wheel speed signal, the signal analyzing unit 130 selects the maximum value of the current wheel speed signal as a maximum value in step S214.

The signal analyzing unit 130 calculates an average of maximum values in real time to calculate an average maximum value in step S216.

The signal analyzing unit 130 calculates a changed amount of the maximum value based on the calculated maximum value of the wheel speed signal and a maximum value of a predetermined normal pressure in step S218.

Thereafter, the low pressure determining unit 140 checks whether the changed amount of the maximum value calculated in the signal analyzing unit 130 exceeds the predetermined reference changed amount in step S220.

As the checking result in step S220, when the changed amount of the maximum value calculated in the signal analyzing unit 130 exceeds the predetermined reference changed amount, the low pressure determining unit 140 determines that the tire mounted on the vehicle is at a low pressure in step S222.

In contrast, as the checking result in step S220, when the changed amount of the maximum value calculated in the signal analyzing unit 130 is equal to or smaller than the predetermined reference changed amount, the low pressure determining unit 140 determines that the tire mounted on the vehicle is at a normal pressure in step S224.

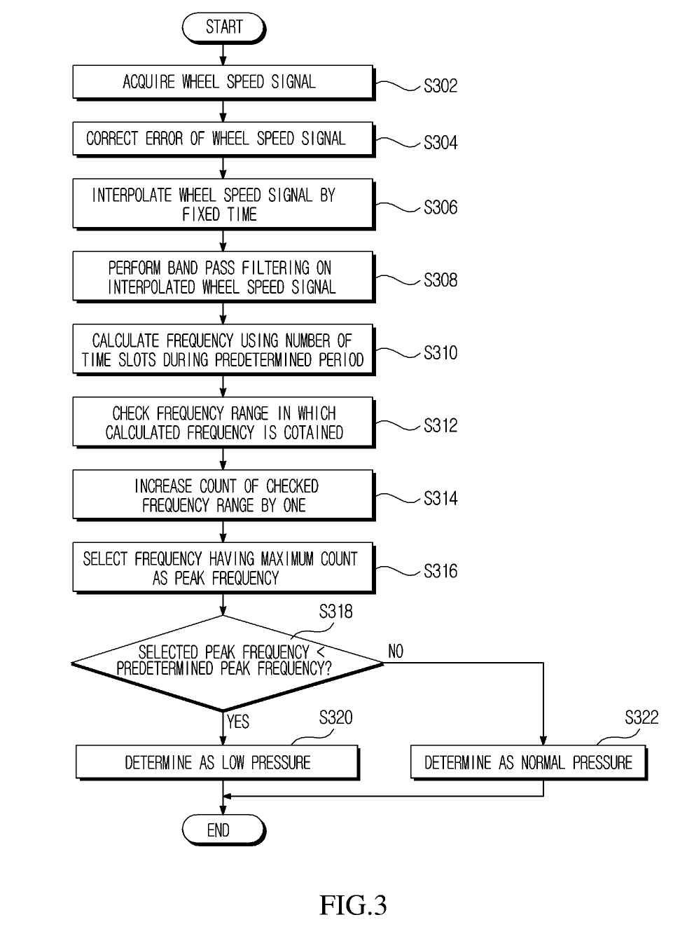

FIG. 3 is a flowchart of a tire pressure monitoring method using zero crossing according to a second exemplary embodiment of the present invention.

The signal acquiring unit 110 acquires a wheel speed signal of a vehicle in step S302.

The signal processing unit 120 corrects an error of the wheel speed signal acquired in the signal acquiring unit 110 in step S304.

The signal processing unit 120 interpolates the wheel speed signal acquired in the signal acquiring unit 110 by a fixed time in step S306.

The signal processing unit 120 performs band-pass filtering on the interpolated wheel speed signal in accordance with a predetermined frequency range in step S308.

The signal analyzing unit 130 calculates a frequency using the number of time slots during the predetermined period in step S310.

Here, the signal analyzing unit 130 checks a frequency range in which the frequency calculated in the signal processing unit 120 is contained in step S312.

Next, the signal analyzing unit 130 increases the count of the checked frequency range by one in step S314.

Next, the signal analyzing unit 130 selects a frequency having a maximum count among the frequency range counts of zero crossing in which the frequency calculated in the signal processing unit 120 is contained, as a peak frequency in step S316.

The low pressure determining unit 140 checks whether the peak frequency selected in the signal analyzing unit 130 is lower than the predetermined peak frequency in step S318.

As the checking result in step S318, when the peak frequency selected in the signal analyzing unit 130 is lower than the predetermined peak frequency, the low pressure determining unit 140 determines that the tire mounted on the vehicle is at a low pressure in step S320.

In contrast, as the checking result in step S318, when the peak frequency selected in the signal analyzing unit 130 is equal to or higher than the predetermined peak frequency, the low pressure determining unit 140 determines that the tire mounted on the vehicle is at a normal pressure in step S322.

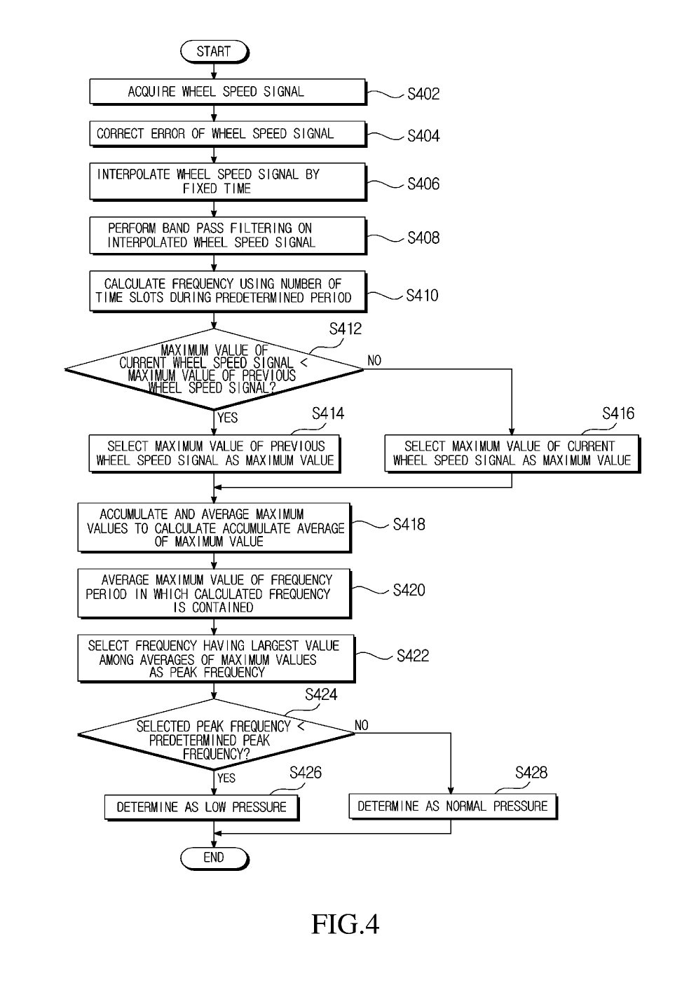

FIG. 4 is a flowchart of a tire pressure monitoring method using zero crossing according to a third exemplary embodiment of the present invention.

The signal acquiring unit 110 acquires a wheel speed signal of a vehicle in step S402.

The signal processing unit 120 corrects an error of the wheel speed signal acquired in the signal acquiring unit 110 in step S404.

The signal processing unit 120 interpolates the wheel speed signal acquired in the signal acquiring unit 110 by a fixed time in step S406.

The signal processing unit 120 performs band-pass filtering on the interpolated wheel speed signal in accordance with a predetermined frequency range in step S408.

The signal analyzing unit 130 calculates a frequency using the number of time slots during the predetermined period in step S410.

In the meantime, the signal analyzing unit 130 checks whether the maximum value of the current wheel speed signal is smaller than the maximum value of the previous wheel speed signal in step S412.

As the checking result in step S412, when the maximum value of the current wheel speed signal is smaller than the maximum value of the previous wheel speed signal, the signal analyzing unit 130 selects the maximum value of the previous wheel speed signal as a maximum value in step S414.

In contrast, as the checking result in step S412, when the maximum value of the current wheel speed signal is equal to or larger than the maximum value of the previous wheel speed signal, the signal analyzing unit 130 selects the maximum value of the current wheel speed signal as a maximum value in step S416.

The signal analyzing unit 130 accumulates and averages maximum values to calculate an accumulated average of the maximum value in step S418.

Here, the signal analyzing unit 130 calculates an average of the maximum values of a frequency range in which the frequency calculated in the signal processing unit 120 is contained in step S420.

Next, the signal analyzing unit 130 selects the highest frequency among the averages of the maximum values as a peak frequency in step S422.

The low pressure determining unit 140 checks whether the peak frequency selected in the signal analyzing unit 130 is lower than the predetermined peak frequency in step S424.

As the checking result in step S424, when the peak frequency selected in the signal analyzing unit 130 is lower than the predetermined peak frequency, the low pressure determining unit 140 determines that the tire mounted on the vehicle is at a low pressure in step S426.

In contrast, as the checking result in step S424, when the peak frequency selected in the signal analyzing unit 130 is equal to or higher than the predetermined peak frequency, the low pressure determining unit 140 determines that the tire mounted on the vehicle is at a normal pressure in step S428.

FIG. 5 is an exemplary view of a wheel speed signal of tires with a low pressure and a normal pressure which is applied to an exemplary embodiment of the present invention.

A wheel speed signal 501 of the normal pressure tire and a wheel speed signal 502 of a low pressure tire are illustrated in FIG. 5.

When the normal pressure of the tire is changed to a low pressure, the frequency tends to be decreased. In a case of the peak frequency, the peak frequency of the wheel speed signal 502 of the low pressure tire is lower than the peak frequency of the wheel speed signal 501 of the normal pressure tire. An entire frequency range of the wheel speed signal 502 of the low pressure tire is similar to that of the wheel speed signal 501 of the normal pressure tire. However, the frequency value is entirely decreased as compared with the frequency of the wheel speed signal 501 of the normal pressure tire.

In the meantime, when the normal pressure of the tire is changed to a low pressure, the frequency is decreased but the gain tends to be increased.

In the case of the maximum value of the wheel speed signal, the maximum value of the wheel speed signal 502 of the low pressure tire is larger than the maximum value of the wheel speed signal 501 of the normal pressure tire. An entire frequency range of the wheel speed signal 502 of the low pressure tire is similar to that of the wheel speed signal 501 of the normal pressure tire. However, the signal value is entirely increased as compared with the gain of the wheel speed signal 501 of the normal pressure tire.

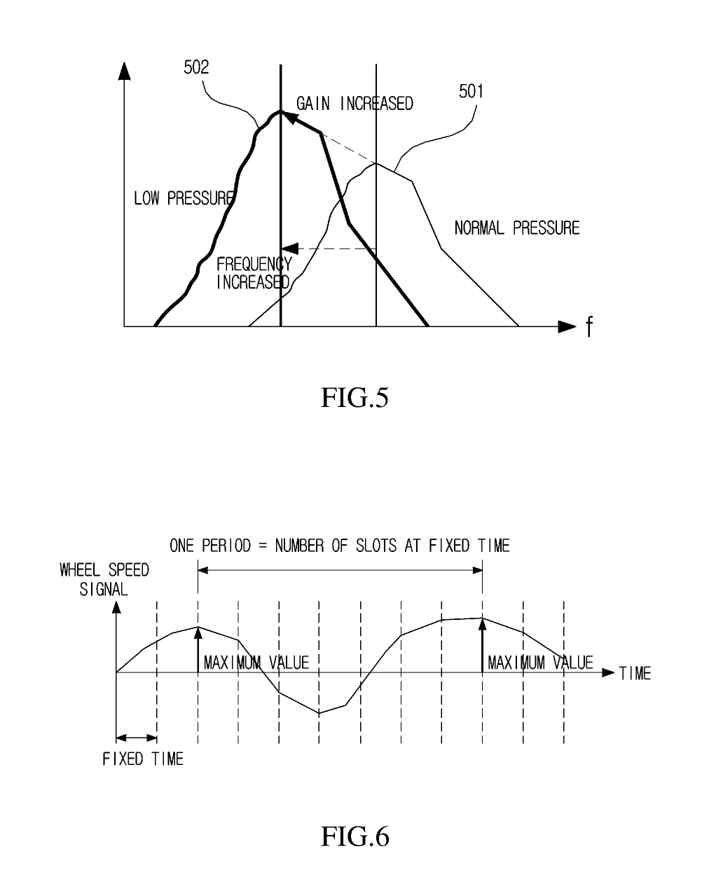

FIG. 6 is an exemplary view of a band-pass filtered time sequential signal which is applied to an exemplary embodiment of the present invention.

The signal processing unit 120 performs the band pass filtering on the wheel speed signal and the band pass filtered wheel speed is interpolated by a fixed time. That is, the signal processing unit 120 interpolates the wheel speed signal by the fixed signal to sample the wheel speed signal at every fixed time. The values sampled at every fixed time may be used to calculate the maximum value or count the frequency range. Here, the band pass filtered time sequential signal is divided by a fixed number.

As illustrated in FIG. 6, the signal analyzing unit 130 may calculate a maximum value of the previous wheel speed signal and a maximum value of the current wheel speed signal using zero crossing.

Further, the signal analyzing unit 130 calculates a frequency for one period using a time for the one period. Here, one period corresponds to the number of fixed time slots.

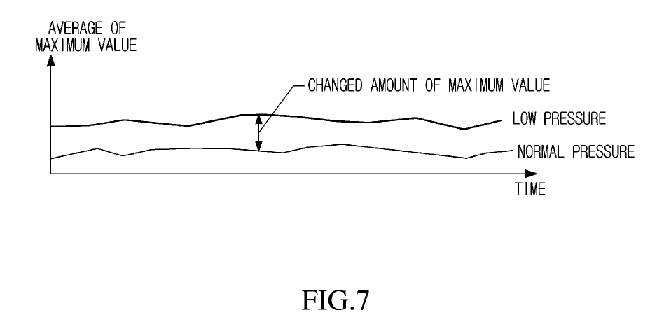

FIG. 7 is an exemplary view of a changed amount of a maximum value of a low pressure and a normal pressure according to a first exemplary embodiment of the present invention.

FIG. 7 illustrates an average of maximum values on a time axis with respect to the wheel speed signal of the low pressure tire according to the first exemplary embodiment of the present invention.

The signal analyzing unit 130 calculates a changed amount of the maximum value by comparing the maximum value of the wheel speed signal of the low pressure tire and a maximum value of a predetermined normal pressure. Here, the average of the maximum values of the low pressure tire and the average of the maximum values of the normal pressure tire are changed.

In this case, the signal analyzing unit 130 compares the calculated average maximum value with an average maximum value of the predetermined normal pressure to calculate a changed amount of the maximum value. As an example, the signal analyzing unit 130 subtracts the maximum value of the wheel speed signal of the low pressure tire from the maximum value of the predetermined normal pressure to calculate the changed amount of the maximum value.

The low pressure determining unit 140 determines that the pressure is the low pressure when the changed amount of the maximum value exceeds the predetermined reference changed amount while monitoring the changed amount of the maximum value calculated in the signal analyzing unit 130 which is flexibly changed. In this case, an influence of a gain of the low pressure tire which is increased as compared with the gain of the normal pressure tire is used.

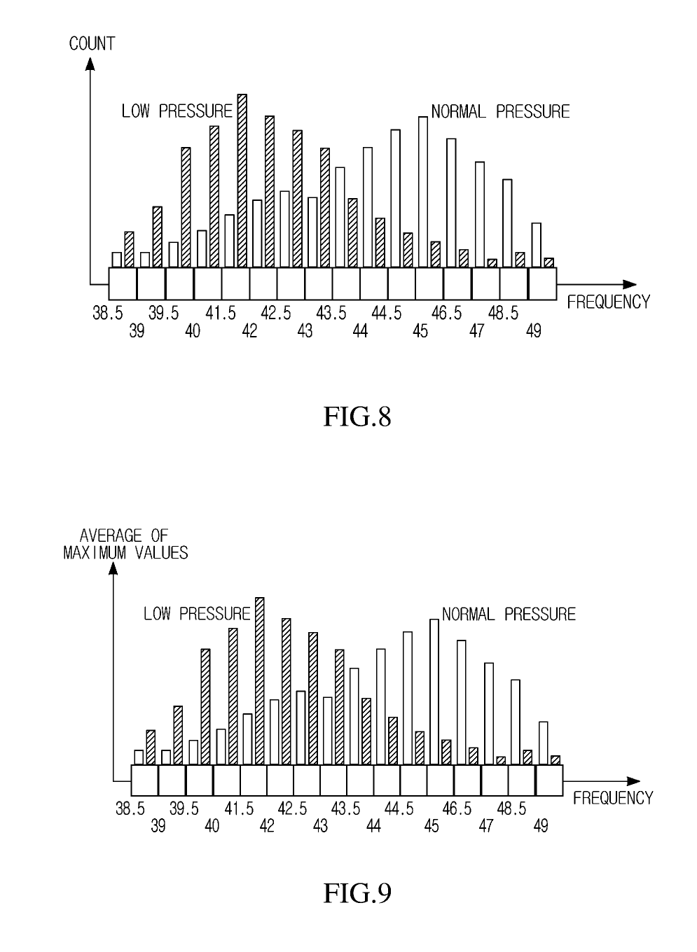

FIG. 8 is an exemplary view of a count within a zero crossing frequency range according to a second exemplary embodiment of the present invention.

In FIG. 8, a count of the frequency range of zero crossing with respect to the entire frequency range of the low pressure and normal pressure tires according to the second exemplary embodiment of the present invention is illustrated.

The entire frequency range is 38.5 Hz to 49 Hz. The entire frequency range is divided by a 0.5 Hz of unit frequency. Here, the unit frequency is not limited to a specific frequency.

The signal analyzing unit 130 checks the frequency range of zero crossing in which the frequency calculated in the entire frequency range which is divided by 0.5 Hz unit frequency is contained to increase the frequency range count.

Thereafter, when the frequency characteristic of the interpolated wheel speed signal of the normal pressure tire is checked, the count of the frequency range is smoothly increased from a frequency of 38.5 Hz. Thereafter, the peak frequency has a peak frequency in the frequency range of 45 Hz to 46.5 Hz. Next, the count of the frequency range is sharply decreased after the peak frequency.

In contrast, when the frequency characteristic of the interpolated wheel speed signal of the low pressure tire is checked, the count of the frequency range is sharply increased from a frequency of 38.5 Hz. Thereafter, the peak frequency has a peak frequency in the frequency range of 41.5 Hz to 42 Hz. That is, the frequency of the low pressure tire has a frequency value which is decreased as compared with the frequency of the normal pressure tire. Next, the count of the frequency range is smoothly decreased after the peak frequency.

After the count of the frequency range is repeatedly increased, the count of the frequency range of the normal pressure tire has a maximum value in the frequency range of 45 Hz to 46.5 Hz.

In contrast, after the count of the frequency range is repeatedly increased, the count of the frequency range of the low pressure tire has a maximum value in the frequency range of 41.5 Hz to 42 Hz.

As described above, referring to FIG. 9, the signal analyzing unit 130 selects the frequency range of 45 Hz to 46.5 Hz as a peak frequency of the normal pressure tire and selects the frequency range of 41.5 to 42 Hz as the peak frequency of the low pressure tire.

In FIG. 9, an average of maximum values of zero crossing with respect to the entire frequency range of the low pressure and normal pressure tires according to the third exemplary embodiment of the present invention is illustrated.

The entire frequency range is 38.5 Hz to 49 Hz. The entire frequency range is divided by a 0.5 Hz of unit frequency. Here, the unit frequency is not limited to a specific frequency.

The signal analyzing unit 130 checks the frequency range of zero crossing in which the frequency calculated in the entire frequency range which is divided by 0.5 Hz unit frequency is contained to calculate an average of the maximum values of the frequency range.

Thereafter, when the average characteristic of the maximum value of the interpolated wheel speed signal of the normal pressure tire is checked, the average of the maximum value is smoothly increased from a frequency of 38.5 Hz. Thereafter, the peak frequency has the largest average of maximum values in the frequency range of 45 Hz to 46.5 Hz. Next, the average of the maximum value is sharply decreased after the peak frequency.

In contrast, when the average characteristic of the maximum value of the interpolated wheel speed signal of the low pressure tire is checked, the average of the maximum value is sharply increased from a frequency of 38.5 Hz. Thereafter, the peak frequency has the largest average of the maximum value in the frequency range of 41.5 Hz to 42 Hz. That is, the frequency of the low pressure tire has a peak frequency value which is higher than the frequency of the normal pressure tire. Next, the average of the maximum value is smoothly decreased after the peak frequency.

After the average of the maximum value is repeatedly increased, the count of the frequency range of the normal pressure tire has the largest average of a maximum value in the frequency range of 45 Hz to 46.5 Hz.

In contrast, after the count of the frequency range is repeatedly increased, the count of the frequency range of the low pressure tire has the largest average of the maximum value in the frequency range of 41.5 Hz to 42 Hz.

As described above, referring to FIG. 9, the signal analyzing unit 130 selects the frequency range of 45 Hz to 46.5 Hz as a peak frequency of the normal pressure tire and selects the frequency range of 41.5 to 42 Hz as the peak frequency of the low pressure tire.

It will be appreciated by those skilled in the art that the present invention as described above may be implemented into other specific forms without departing from the technical spirit thereof or essential characteristics. Thus, it is to be appreciated that embodiments described above are intended to be illustrative in every sense, and not restrictive. The scope of the present invention is represented by the claims to be described below rather than the detailed description, and it is to be interpreted that the meaning and scope of the claims and all the changes or modified forms derived from the equivalents thereof come within the scope of the present invention.

In the meantime, exemplary embodiments of the present invention have been disclosed in the specification and the drawings and specific terms are used therein. Even though specific terms are used, this is used for a general meaning to easily explain the technical content of the present invention and help to understand the invention. However, it does not limit the scope of the present invention. It is obvious to those skilled in the art that modifications based on the technical spirit of the present invention, other than the disclosed exemplary embodiment are allowed.

What is claimed is:

1. A tire pressure monitoring method using zero crossing, comprising:
acquiring a wheel speed signal of a vehicle;
interpolating the obtained wheel speed signal by a fixed time;
calculating a maximum value of the interpolated wheel speed signal using a time range of zero crossing;
calculating a changed amount of the maximum value by comparing the maximum value of the calculated wheel speed signal and the maximum value of the predetermined normal pressure; and
determining a low pressure of a tire mounted on a vehicle using the calculated changed amount of the maximum value.

2. The method according to claim 1, further comprising:
correcting an error of the acquired wheel speed signal.

3. The method according to claim 1, further comprising:
performing band pass filtering on the interpolated wheel speed signal in accordance with the predetermined frequency range.

4. The method according to claim 1, wherein in the calculating of a maximum value, a value at an inflection point at which a current value of a wheel speed signal is lower than a previous value of a wheel speed signal within a time range of zero crossing is selected as the maximum value and an average of the selected maximum value is calculated in real time to calculate the average maximum value.

5. The method according to claim 4, wherein in the calculating of a changed amount of the maximum value, the calculated average maximum value is compared with the average maximum value of the predetermined normal pressure to calculate the changed amount of the maximum value.

6. The method according to claim 1, wherein in the determining of a low pressure, when the calculated changed amount of the maximum value is equal to or smaller than the predetermined reference changed amount, the tire is determined to be at a normal pressure and when the calculated changed amount of the maximum value exceeds the predetermined reference changed amount, the tire is determined to be at a low pressure.

7. A tire pressure monitoring method using zero crossing, comprising:
acquiring a wheel speed signal of a vehicle;
interpolating the obtained wheel speed signal by a fixed time;
calculating a frequency using the number of time slots of the interpolated wheel speed signal;
selecting a peak frequency using a frequency range count of zero crossing in which the calculated frequency is contained; and
determining a low pressure of a tire mounted on a vehicle using the selected peak frequency.

8. The method according to claim 7, further comprising:
correcting an error of the acquired wheel speed signal.

9. The method according to claim 7, further comprising:
performing band pass filtering on the interpolated wheel speed signal in accordance with the predetermined frequency range.

10. The method according to claim 7, wherein in the calculating of a frequency, the frequency is calculated using the number of time slots of the interpolated wheel speed signal during the predetermined period, in order to remove disturbance.

11. The method according to claim 7, wherein in the selecting of a peak frequency, a count of the frequency range is increased by checking the frequency range of zero crossing in which the calculated frequency is contained and a frequency range having a maximum count among the increased frequency range counts is selected as a peak frequency.

12. The method according to claim 7, wherein in the determining of a low pressure, when the selected peak frequency is equal to or higher than the predetermined peak frequency, the tire is determined to be at a normal pressure and when the selected peak frequency is lower than the predetermined peak frequency, the tire is determined to be at a low pressure.

13. A tire pressure monitoring method using zero crossing, comprising:
acquiring a wheel speed signal of a vehicle;
interpolating the obtained wheel speed signal by a fixed time;
calculating a frequency using a number of time slots of the interpolated wheel speed signal;
calculating a maximum value within a frequency range of zero crossing of the interpolated wheel speed signal;
selecting a peak frequency using a maximum value within a frequency range of zero crossing in which the calculated frequency is contained; and
determining a low pressure of a tire mounted on a vehicle using the selected peak frequency.

14. The method according to claim 13, further comprising:
correcting an error of the acquired wheel speed signal.

15. The method according to claim 13, further comprising:
performing a band pass filtering on the interpolated wheel speed signal in accordance with the predetermined frequency range.

16. The method according to claim 13, wherein in the calculating of a frequency, the frequency is calculated using the number of time slots of the interpolated wheel speed signal during the predetermined period, in order to remove disturbance.

17. The method according to claim 13, wherein in the calculating of a maximum value, a value at an inflection point at which a current value of a wheel speed signal is lower than a previous value of a wheel speed signal within a frequency range of zero crossing is selected as the maximum value and the selected maximum value is accumulated and averaged.

18. The method according to claim 13, wherein in the selecting of a peak frequency, the maximum values within the frequency range of zero crossing in which the calculated frequency is contained are averaged and a frequency having the largest value among the average of the maximum value is selected as a peak frequency.

19. The method according to claim 13, wherein in the determining of a low pressure, when the selected peak frequency is equal to or higher than the predetermined peak frequency, the pressure is determined as a normal pressure and when the selected peak frequency is lower than the predetermined peak frequency, the pressure is determined as a low pressure.

20. A tire pressure monitoring apparatus using zero crossing, comprising:
a signal acquiring unit which acquires a wheel speed signal of a vehicle;
a signal processing unit which interpolates the obtained wheel speed signal by a fixed time;
a signal analyzing unit which calculates a maximum value of the interpolated wheel speed signal using a time range of zero crossing or calculate a frequency using the number of time slots of the interpolated wheel speed signal and calculates a changed amount of the maximum value or selects a peak frequency using the calculated maximum value or the frequency of the wheel speed signal; and
a low pressure determining unit which determines a low pressure of a tire mounted on a vehicle using the calculated changed amount of the maximum value or the selected peak frequency.

21. The apparatus according to claim 20, wherein the signal analyzing unit compares the maximum value of the calculated wheel speed signal with the maximum value of the predetermined normal pressure to calculate the changed amount of the maximum value.

22. The apparatus according to claim 20, wherein the signal analyzing unit selects a peak frequency using a frequency range count of zero crossing in which the calculated frequency is contained.

23. The apparatus according to claim 20, wherein the signal analyzing unit calculates the maximum value within the frequency range of zero crossing of the interpolated wheel speed signal and selects the peak frequency using the maximum value in the frequency range of zero crossing in which the calculated frequency is contained.
